(19) United States
(12) Patent Application Publication
(10) Pub. No.: US 2026/0190184 A1
(43) Pub. Date: Jul. 2, 2026

(54) SEMICONDUCTOR CERAMIC HEATER AND DESIGN METHOD THEREFOR

(71) Applicants: XI'AN UNIVERSITY OF ARCHITECTURE AND TECHNOLOGY, Xi'an City (CN); SHANGHAI UNIVERSITY, Shanghai (CN)

(72) Inventors: Qiang ZHEN, Shanghai (CN); Shunqi ZHANG, Shanghai (CN); Feng DUAN, Xi'an City, Shaanxi Province (CN)

(73) Assignees: XI'AN UNIVERSITY OF ARCHITECTURE AND TECHNOLOGY, Xi'an City (CN); SHANGHAI UNIVERSITY, Shanghai (CN)

(21) Appl. No.: 19/436,709

(22) Filed: Dec. 30, 2025

(30) Foreign Application Priority Data
Jan. 2, 2025 (CN) 202510000205.8

(51) Int. Cl. H05B 3/28; H10P 72/00

(52) U.S. Cl. CPC H05B 3/283; H10P 72/0432

(57) ABSTRACT

A semiconductor ceramic heater and a design method therefor. The design method includes: establishing a length expression for each turn of a heating wire of the semiconductor ceramic heater, thereby determining an expression of thermal energy generated by each turn of the heating wire; establishing an area expression for each region of a ceramic disc partitioned by the heating wire; determining a thermal energy model allocated to each region according to the area expression and the expression of the thermal energy; determining a radiative heat release quantity model of each region according to the area expression and a target temperature of each region; and calculating the radius of each turn of the heating wire and the thermal energy required to reach the target temperature by combining the thermal energy model and the radiative heat release quantity model.

### CROSS REFERENCE TO RELATED APPLICATION

This application claims foreign priority benefits under 35 U.S.C. § 119 (a)-(d) to Chinese Patent Application No. 202510000205.8, filed Jan. 2, 2025, the disclosure of which is hereby incorporated by reference herein in its entirety.

### TECHNICAL FIELD

The present application relates to the technical field of semiconductor ceramic heaters, and in particular, to a semiconductor ceramic heater and a design method therefor.

### BACKGROUND

A circular ceramic heater, as the major equipment for heating semiconductor wafers, requires crucial temperature uniformity, which directly impacts the wafer yield. With the gradual advancement of the semiconductor industry, the requirements for temperature uniformity in wafer heaters have further increased. However, improving temperature uniformity in heaters often involves simulation and experimentation, which are time-consuming and labor-intensive. Therefore, proposing a method that can simplify the design process of semiconductor ceramic heaters is of paramount importance.

### SUMMARY

An objective of the present application is to provide a semiconductor ceramic heater and a design method therefor, allowing the design process of the semiconductor ceramic heater to be simplified and the temperature uniformity thereof to be improved.

To achieve the above objective, the present application provides the following technical solutions.

In a first aspect, the present application provides a design method for a semiconductor ceramic heater, including: establishing a length expression for each turn of a heating wire of the semiconductor ceramic heater, the length expression being related to a radius of each turn of the heating wire; determining an expression of thermal energy generated by each turn of the heating wire according to the length expression for each turn of the heating wire, the expression of the thermal energy being related to the radius of each turn of the heating wire and thermal energy required to reach a target temperature; establishing an area expression for each region of a ceramic disc partitioned by the heating wire, the area expression being related to the radius of each turn of the heating wire; determining a thermal energy model allocated to each region according to the area expression for each region and the expression of the thermal energy generated by each turn of the heating wire; determining a radiative heat release quantity model of each region according to the area expression for each region and a target temperature of each region; and calculating the radius of each turn of the heating wire and the thermal energy required to reach the target temperature by combining the thermal energy model allocated to each region and the radiative heat release quantity model of each region.

Optionally, the length expression is as follows:

$$\begin{matrix}{L}_{1} = 2 π {r}_{1} + {r}_{2} + {r}_{1} - 2 {d}_{0} ; \\ {L}_{i} = 2 π {r}_{i} + {r}_{i + 1} - {r}_{i - 1} - 2 {d}_{0} ; \\ {L}_{n} = 2 π {r}_{n} + {r}_{n} - {r}_{n - 1} - 2 {d}_{0} ;\end{matrix}$$

where L₁ represents a length of a first turn of the heating wire; r₁ represents a radius of the first turn of the heating wire; r₂ represents a radius of a second turn of the heating wire; Lᵢ represents a length of an i-th turn of the heating wire; rᵢ represents a radius of the i-th turn of the heating wire; Tᵢ₊₁ represents a radius of an (i+1)-th turn of the heating wire; rᵢ₋₁ represents a radius of an (i−1)-th turn of the heating wire; do represents a spacing between the turns of the heating wire; Lₙ represents a length of an n-th turn of the heating wire; rₙ represents a radius of the n-th turn of the heating wire; rₙ₋₁ represents a radius of an (n−1)-th turn of the heating wire; i=1, 2, . . . , n−1; n represents a total number of turns of the heating wire; and the turns of the heating wire are sequentially defined as 1, 2, . . . , n along a radius direction of the ceramic disc from a center of the ceramic disc.

Optionally, the determining an expression of thermal energy generated by each turn of the heating wire according to the length expression for each turn of the heating wire includes: establishing a total length expression of the heating wire according to the length expression of each turn of the heating wire and a total number of turns of the heating wire; determining, according to where n the total length expression of the heating wire, a heat density expression as

$$η = \frac{P}{L} ,$$

where η represents a heat density; η represents the thermal energy required to reach the target temperature; and L represents a total length of the heating wire; and combining the total length expression of the heating wire and the heat density expression to derive the expression of the thermal energy generated by each turn of the heating wire as Pᵢ=ηLᵢ, where Pᵢ represents thermal energy generated by an i-th turn of the heating wire, and Lᵢ represents a length of the i-th turn of the heating wire.

Optionally, the area expression is as follows:

$$\begin{matrix}{S}_{1} = π {r}_{1}^{2} ; \\ {S}_{i} = π ( {r}_{i}^{2} - {r}_{i - 1}^{2} ) ; \\ {S}_{n + 1} = π ( {R}^{2} - {r}_{n}^{2} ) ;\end{matrix}$$

where S₁ represents an area of an enclosed region of the ceramic disc partitioned by a first turn of the heating wire; Sᵢ represents an area of a region of the ceramic disc partitioned by an i-th turn of the heating wire and an (i−1)-th turn of the heating wire; Sₙ₊₁ represents an area of a region of the ceramic disc partitioned by an n-th turn of the heating wire and an edge of the ceramic disc; r₁ represents a radius of the first turn of the heating wire; rt represents a radius of the i-th turn of the heating wire; rᵢ₋₁ represents a radius of the (i−1)-th turn of the heating wire; rₙ represents a radius of the n-th turn of the heating wire; R represents a radius of the ceramic disc; i=2, . . . , n; n represents a total number of turns of the heating wire; and the turns of the heating wire are sequentially defined as 1, 2, . . . , n along a radius direction of the ceramic disc from a center of the ceramic disc.

Optionally, the thermal energy model is expressed as follows:

$$\begin{matrix}{P}_{{S}_{1}} = {P}_{1} \frac{{S}_{1}}{{S}_{1} + {S}_{2}} ; \\ {P}_{{S}_{i}} = {P}_{i - 1} \frac{{S}_{i}}{{S}_{i - 1} + {S}_{i}} + {P}_{i} \frac{{S}_{i}}{{S}_{i} + {S}_{i + 1}} ; \\ {P}_{{S}_{n + 1}} = {P}_{n} \frac{{S}_{n + 1}}{{S}_{n} + {S}_{n + 1}} ;\end{matrix}$$

where P_{S}_{₁} represents thermal energy allocated to an enclosed region of the ceramic disc partitioned by a first turn of the heating wire; P_{S}_{ᵢ} represents thermal energy allocated to a region of the ceramic disc partitioned by an i-th turn of the heating wire and an (i−1)-th turn of the heating wire; P_{S}_{ₙ₊₁} represents thermal energy allocated to a region of the ceramic disc partitioned by an n-th turn of the heating wire and an edge of the ceramic disc; P₁ represents thermal energy generated by the first turn of the heating wire; Pᵢ₋₁ represents thermal energy generated by the (i−1)-th turn of the heating wire; Pᵢ represents thermal energy generated by the i-th turn of the heating wire; Pₙ represents thermal energy generated by the n-th turn of the heating wire; S₁ represents an area of the enclosed region of the ceramic disc partitioned by the first turn of the heating wire; S₂ represents an area of a region of the ceramic disc partitioned by a second turn of the heating wire and the first turn of the heating wire; Sᵢ₋₁ represents an area of a region of the ceramic disc partitioned by the (i−1)-th turn of the heating wire and an (i−2)-th turn of the heating wire; Sᵢ represents an area of the region of the ceramic disc partitioned by the i-th turn of the heating wire and the (i−1)-th turn of the heating wire; Sᵢ₊₁ represents an area of a region of the ceramic disc partitioned by an (i+1)-th turn of the heating wire and the i-th turn of the heating wire; Sₙ represents an area of a region of the ceramic disc partitioned by the n-th turn of the heating wire and an (n−1)-th turn of the heating wire; Sₙ₊₁ represents an area of the region of the ceramic disc partitioned by the n-th turn of the heating wire and the edge of the ceramic disc; i=2, . . . , n; n represents a total number of turns of the heating wire; and the turns of the heating wire are sequentially defined as 1, 2, . . . , n along a radius direction of the ceramic disc from a center of the ceramic disc.

Optionally, the radiative heat release quantity model is expressed as:

$$\begin{matrix}{E}_{i} = ε δ {T}_{i}^{4} {S}_{i} ; \\ {E}_{n + 1} = ε δ {T}_{n + 1}^{4} {S}_{n + 1} ;\end{matrix}$$

where Eᵢ represents a radiative heat release quantity from an enclosed region of the ceramic disc partitioned by a first turn of the heating wire; Eₙ₊₁ represents a radiative heat release quantity from a region of the ceramic disc partitioned by an n-th turn of the heating wire and an edge of the ceramic disc; ε represents a surface radiative emissivity; ε represents the Boltzmann constant; Tᵢ represents a target temperature of a region of the ceramic disc partitioned by an i-th turn of the heating wire and an (i−1)-th turn of the heating wire; Tₙ₊₁ represents a target temperature of the region of the ceramic disc partitioned by the n-th turn of the heating wire and the edge of the ceramic disc; Sᵢ represents an area of the region of the ceramic disc partitioned by the i-th turn of the heating wire and the (i−1)-th turn of the heating wire; Sₙ₊₁ represents an area of the region of the ceramic disc partitioned by the n-th turn of the heating wire and the edge of the ceramic disc; i=1, 2, . . . , n; n represents a total number of turns of the heating wire; and the turns of the heating wire are sequentially defined as 1, 2, . . . , n along a radius direction of the ceramic disc from a center of the ceramic disc.

Optionally, the calculating the radius of each turn of the heating wire and the thermal energy required to reach the target temperature by combining the thermal energy model allocated to each region and the radiative heat release quantity model of each region includes: in accordance with a principle that, under heat equilibrium, thermal energy allocated to each region is equal to a radiative heat release quantity from each region, combining the thermal energy model allocated to each region and the radiative heat release quantity model of each region to derive an equation set; and solving the equation set to obtain the radius of each turn of the heating wire and the thermal energy required to reach the target temperature.

In a second aspect, the present application provides a semiconductor ceramic heater including a heating wire and a ceramic disc, where the heating wire is coiled around the ceramic disc in a form of concentric circular arcs; and a radius of each turn of the heating wire is determined using the design method for a semiconductor ceramic heater described above.

Optionally, turns of the heating wire are sequentially defined as 1, 2, . . . , n along a radius direction of the ceramic disc from a center of the ceramic disc; a j-th turn of the heating wire to an (n−1)-th turn of the heating wire are in a sawtooth shape; an n-th turn of the heating wire is in the sawtooth shape, or is a circular ring on which a plurality of circles are provided in a uniformly spaced manner; and 1<j<n−1.

Optionally, each turn of the heating wire is a circular ring on which a plurality of circles are provided in a uniformly spaced manner; and a number of circles on an outside circular ring is greater than a number of circles on a neighboring inside circular ring.

According to specific embodiments provided in the present application, the present application has the following technical effects:

The present application provides a semiconductor ceramic heater and a design method therefor. Taking the radius of each turn of the heating wire and the thermal energy required to reach the target temperature as unknown variables, the radius of each turn of the heating wire and the thermal energy required to reach the target temperature may be calculated by combining the thermal energy model allocated to each region and the radiative heat release quantity model of each region. The need for simulation and experimentation is eliminated. The design dimensions of the heating wire can be calculated rapidly and accurately. The heater design process is optimized, allowing the ceramic heater to have excellent temperature uniformity.

### BRIEF DESCRIPTION OF THE DRAWINGS

To describe the technical solutions in the embodiments of the present application or in the related art more clearly, the following briefly describes the accompanying drawings required for describing the embodiments or the related art. Apparently, the accompanying drawings in the following description show some embodiments of the present application, and a person of ordinary skill in the art may still derive other accompanying drawings from these accompanying drawings without creative efforts.

FIG. 1 is a schematic flowchart of a design method for a semiconductor ceramic heater provided by an embodiment of the present disclosure;

FIG. 2 is a schematic diagram of heating wire distribution of a semiconductor ceramic heater provided by an embodiment of the present disclosure;

FIG. 3 is a schematic diagram of heating wire distribution of a semiconductor ceramic heater provided by Embodiment 1 of the present disclosure;

FIG. 4 is a schematic diagram of temperature field distribution of a semiconductor ceramic heater provided by Embodiment 1 of the present disclosure;

FIG. 5 is a schematic diagram of heating wire distribution of a semiconductor ceramic heater provided by Embodiment 2 of the present disclosure;

FIG. 6 is a schematic diagram of temperature field distribution of a semiconductor ceramic heater provided by Embodiment 2 of the present disclosure;

FIG. 7 is a schematic diagram of a first special pattern of heating wire distribution of a semiconductor ceramic heater provided by Embodiment 3 of the present disclosure;

FIG. 8 is a schematic diagram of a second special pattern of heating wire distribution of the semiconductor ceramic heater provided by Embodiment 3 of the present disclosure;

FIG. 9 is a schematic diagram of a third special pattern of heating wire distribution of the semiconductor ceramic heater provided by Embodiment 3 of the present disclosure;

FIG. 10 is a schematic diagram of a first special pattern of temperature field distribution provided by Embodiment 3 of the present disclosure;

FIG. 11 is a schematic diagram of a second special pattern of temperature field distribution provided by Embodiment 3 of the present disclosure; and

FIG. 12 is a schematic diagram of a third special pattern of temperature field distribution provided by Embodiment 3 of the present disclosure.

### DETAILED DESCRIPTION

The technical solutions in the embodiments of the present application are clearly and completely described below with reference to the drawings in the embodiments of the present application. Apparently, the described embodiments are only some rather than all of the embodiments of the present application. All other embodiments obtained by a person of ordinary skill in the art based on the embodiments of the present application without creative efforts shall fall within the protection scope of the present application.

To make the above objective, features, and advantages of the present application more obvious and easier to understand, the present application will be further described in detail with reference to the accompanying drawings and specific implementations.

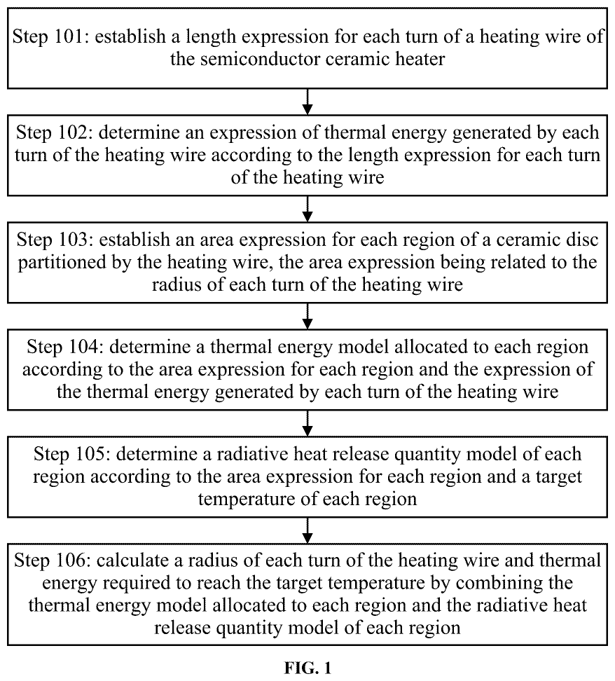

In an exemplary embodiment, as shown in FIG. 1, there is provided a design method for a semiconductor ceramic heater, including step 101 to step 106 as follows.

In step 101, a length expression for each turn of a heating wire of the semiconductor ceramic heater is established, where the length expression is related to a radius of each turn of the heating wire.

In step 102, an expression of thermal energy generated by each turn of the heating wire is determined according to the length expression for each turn of the heating wire, where the expression of the thermal energy is related to the radius of each turn of the heating wire and thermal energy required to reach a target temperature.

In step 103, an area expression for each region of a ceramic disc partitioned by the heating wire is established, where the area expression is related to the radius of each turn of the heating wire.

In step 104, a thermal energy model allocated to each region is determined according to the area expression for each region and the expression of the thermal energy generated by each turn of the heating wire.

In step 105, a radiative heat release quantity model of each region is determined according to the area expression for each region and a target temperature of each region.

In step 106, the radius of each turn of the heating wire and the thermal energy required to reach the target temperature are ascertained by combining the thermal energy model allocated to each region and the radiative heat release quantity model of each region.

When implementing the above step 101 to step 106, taking the radius of each turn of the heating wire and the thermal energy required to reach the target temperature as unknown variables, the radius of each turn of the heating wire and the thermal energy required to reach the target temperature may be calculated by combining the thermal energy model allocated to each region and the radiative heat release quantity model of each region. The need for simulation and experimentation is eliminated, thus reducing experimental materials and time cost. The design dimensions of the heating wire can be calculated rapidly and accurately. The design process of the heater is optimized, allowing the ceramic heater to have excellent temperature uniformity.

In another exemplary embodiment of the present application, the length expression is as follows:

$$\begin{matrix}{L}_{1} = 2 π {r}_{1} + {r}_{2} + {r}_{1} - 2 {d}_{0} ; \\ {L}_{i} = 2 π {r}_{i} + {r}_{i + 1} - {r}_{i - 1} - 2 {d}_{0} ; \\ {L}_{n} = 2 π {r}_{n} + {r}_{n} - {r}_{n - 1} - 2 {d}_{0} ;\end{matrix}$$

where L₁ represents a length of a first turn of the heating wire; r₁ represents a radius of the first turn of the heating wire; r₂ represents a radius of a second turn of the heating wire; Lᵢ represents a length of an i-th turn of the heating wire; rᵢ represents a radius of the i-th turn of the heating wire; rᵢ₊₁ represents a radius of an (1+1)-th turn of the heating wire; rᵢ₋₁ represents a radius of an (i−1)-th turn of the heating wire; do represents a spacing between the turns of the heating wire; Lₙ represents a length of an n-th turn of the heating wire; rₙ represents a radius of the n-th turn of the heating wire; rₙ₋₁ represents a radius of an (n−1)-th turn of the heating wire; i=1, 2, . . . , n−1; n represents a total number of turns of the heating wire; and the turns of the heating wire are sequentially defined as 1, 2, . . . , n along a radius direction of the ceramic disc from a center of the ceramic disc.

In another exemplary embodiment of the present application, the above step 102 may be replaced with step 201 to step 203 as follows.

In step 201, a total length expression of the heating wire is established according to the length expression of each turn of the heating wire and a total number of turns of the heating wire.

In step 202, according to the total length expression of the heating wire, a heat density expression is determined as

$$η = \frac{P}{L} ,$$

where η represents a heat density; η represents the thermal energy required to reach the target temperature; and L represents a total length of the heating wire.

In step 203, the total length expression of the heating wire and the heat density expression are combined to derive the expression of the thermal energy generated by each turn of the heating wire as Pᵢ=ηLᵢ, where Pᵢ represents thermal energy generated by an i-th turn of the heating wire, and Lᵢ represents a length of the i-th turn of the heating wire.

In another exemplary embodiment of the present application, the area expression is as follows:

$$\begin{matrix}{S}_{1} = π {r}_{1}^{2} ; \\ {S}_{i} = π ( {r}_{i}^{2} - {r}_{i - 1}^{2} ) ; \\ {S}_{n + 1} = π ( {R}^{2} - {r}_{n}^{2} ) ;\end{matrix}$$

where S₁ represents an area of an enclosed region of the ceramic disc partitioned by a first turn of the heating wire; Sᵢ represents an area of a region of the ceramic disc partitioned by an i-th turn of the heating wire and an (i−1)-th turn of the heating wire; Sₙ₊₁ represents an area of a region of the ceramic disc partitioned by an n-th turn of the heating wire and an edge of the ceramic disc; r₁ represents a radius of the first turn of the heating wire; rᵢ represents a radius of the i-th turn of the heating wire; rᵢ₋₁ represents a radius of the (i−1)-th turn of the heating wire; rₙ represents a radius of the n-th turn of the heating wire; R represents a radius of the ceramic disc; i=2, . . . , n; n represents a total number of turns of the heating wire; and the turns of the heating wire are sequentially defined as 1, 2, . . . , n along a radius direction of the ceramic disc from a center of the ceramic disc.

In another exemplary embodiment of the present application, the thermal energy model is as follows:

$$\begin{matrix}{P}_{{S}_{1}} = {P}_{1} \frac{{S}_{1}}{{S}_{1} + {S}_{2}} ; \\ {P}_{{S}_{i}} = {P}_{i - 1} \frac{{S}_{i}}{{S}_{i - 1} + {S}_{i}} + {P}_{i} \frac{{S}_{i}}{{S}_{i} + {S}_{i + 1}} ; \\ {P}_{{S}_{n + 1}} = {P}_{n} \frac{{S}_{n + 1}}{{S}_{n} + {S}_{n + 1}} ;\end{matrix}$$

where P_{S}_{₁} represents thermal energy allocated to an enclosed region of the ceramic disc partitioned by a first turn of the heating wire; P_{S}_{ᵢ} represents thermal energy allocated to a region of the ceramic disc partitioned by an i-th turn of the heating wire and an (i−1)-th turn of the heating wire; P_{S}_{ₙ₊₁} represents thermal energy allocated to a region of the ceramic disc partitioned by an n-th turn of the heating wire and an edge of the ceramic disc; P₁ represents thermal energy generated by the first turn of the heating wire; Pᵢ₋₁ represents thermal energy generated by the (i−1)-th turn of the heating wire; Pᵢ represents thermal energy generated by the i-th turn of the heating wire; Pₙ represents thermal energy generated by the n-th turn of the heating wire; S₁ represents an area of the enclosed region of the ceramic disc partitioned by the first turn of the heating wire; S₂ represents an area of a region of the ceramic disc partitioned by a second turn of the heating wire and the first turn of the heating wire; Sᵢ₋₁ represents an area of a region of the ceramic disc partitioned by the (i−1)-th turn of the heating wire and an (i−2)-th turn of the heating wire; Sᵢ represents an area of the region of the ceramic disc partitioned by the i-th turn of the heating wire and the (i−1)-th turn of the heating wire; Sᵢ+1 represents an area of a region of the ceramic disc partitioned by an (i+1)-th turn of the heating wire and the i-th turn of the heating wire; Sₙ represents an area of a region of the ceramic disc partitioned by the n-th turn of the heating wire and an (n−1)-th turn of the heating wire; Sₙ₊₁ represents an area of the region of the ceramic disc partitioned by the n-th turn of the heating wire and the edge of the ceramic disc; i=2, . . . , n; n represents a total number of turns of the heating wire; and the turns of the heating wire are sequentially defined as 1, 2, . . . , n along a radius direction of the ceramic disc from a center of the ceramic disc.

In another exemplary embodiment of the present application, the radiative heat release quantity model is expressed as:

$$\begin{matrix}{E}_{i} = ε δ {T}_{i}^{4} {S}_{i} ; \\ {E}_{n + 1} = ε δ {T}_{n + 1}^{4} {S}_{n + 1} ;\end{matrix}$$

where Eᵢ represents a radiative heat release quantity from an enclosed region of the ceramic disc partitioned by a first turn of the heating wire; Eₙ₊₁ represents a radiative heat release quantity from a region of the ceramic disc partitioned by an n-th turn of the heating wire and an edge of the ceramic disc; ε represents a surface radiative emissivity; ε represents the Boltzmann constant; Tᵢ represents a target temperature of a region of the ceramic disc partitioned by an i-th turn of the heating wire and an (i−1)-th turn of the heating wire; Tₙ₊₁ represents a target temperature of the region of the ceramic disc partitioned by the n-th turn of the heating wire and the edge of the ceramic disc; Sᵢ represents an area of the region of the ceramic disc partitioned by the i-th turn of the heating wire and the (i−1)-th turn of the heating wire; Sₙ₊₁ represents an area of the region of the ceramic disc partitioned by the n-th turn of the heating wire and the edge of the ceramic disc; i=1, 2, . . . , n; n represents a total number of turns of the heating wire; and the turns of the heating wire are sequentially defined as 1, 2, . . . , n along a radius direction of the ceramic disc from a center of the ceramic disc.

In another exemplary embodiment of the present application, the above step 106 may be replaced with step 301 to step 302 as follows.

In step 301, in accordance with a principle that, under heat equilibrium, thermal energy allocated to each region is equal to a radiative heat release quantity from each region, the thermal energy model allocated to each region and the radiative heat release quantity model of each region are combined to derive an equation set.

In step 302, the equation set is solved to obtain the radius of each turn of the heating wire and the thermal energy required to reach the target temperature.

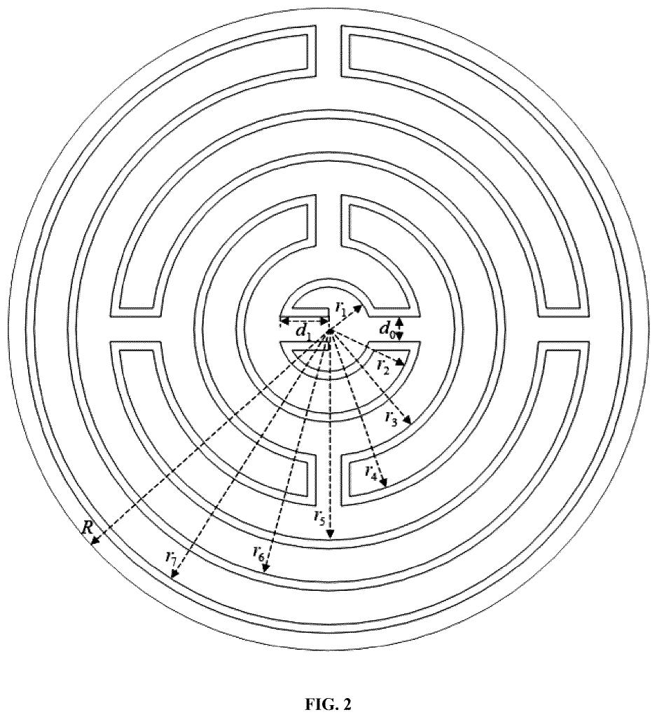

The method of the present application is described in detail below by taking as an example that the total number of turns of the heating wire of the semiconductor ceramic heater shown in FIG. 2 is 7.

Shape parameters in FIG. 2 are as follows: R represents the radius of the ceramic disc; rt represents the radius of the i-th turn of the heating wire, i=1, 2, 3, . . . , 7, and n=7; and the 7 turns of the heating wires partition the ceramic disc into 8 regions, which are sequentially defined as region 1, region 2, region 3, region 4, region 5, region 6, region 7, and region 8 along the radius direction of the ceramic disc from the center of the ceramic disc; do represents the spacing between the turns of the heating wire, which is approximately equal to a width of the heating wire gap; and d₁ represents a length of the heating wire at a lead which is connected to two ends of the first turn of the heating wire.

Parameters of the ceramic disc are set as follows: the surface radiative emissivity ε=0.88; the Boltzmann constant δ=5.67×10⁻² W/mm²·K⁴; T represents the target temperature, and the target temperature of each region of the ceramic disc partitioned by the heating wire is equal to T; and P represents the thermal energy required to reach the target temperature.

Among the above physical variables, the known variables are R, d⁰, d¹, and T, which need to be input manually; and the unknown variables are rᵢ and P.

The total length of the heating wire is calculated by:

$$L = 2 π {\sum }_{i = 1}^{7} {r}_{i} + 2 {r}_{7} - 13 {d}_{0} .$$

The heat density is calculated by:

$$η = \frac{P}{L} .$$

The length of each turn of the heating wire is calculated as follows.

The first turn: L₁=2πr₁+r₂+r₁−2d₀.

The second turn: L₂=2πr₂+r₃−r₁−2d₀.

The (n−1)-th turn: Lₙ₋₁=2πrₙ₋₁+rₙ−rₙ₋₂−2d₀.

The n-th turn: Lₙ=2πrₙ+rₙ−rₙ₋₁−2d₀.

The thermal energy generated by each turn of the heating wire is calculated as follows.

The first turn: P₁=ηL₁.

The second turn: P₂=ηL₂.

The (n−1)-th turn: Pₙ₋₁=ηLₙ₋₁.

The n-th turn: Pₙ=ηLₙ.

The n turns of the heating wire partition the ceramic disc into (n+1) regions, and in this case, n=7. The area of each region is calculated as follows.

Region 1:

$${S}_{1} = π {r}_{1}^{2} .$$

Region 2:

$${S}_{2} = π ( {r}_{2}^{2} - {r}_{1}^{2} ) .$$

Region n−1:

$${S}_{n - 1} = π ( {r}_{n - 1}^{2} - {r}_{n - 2}^{2} ) .$$

Region n:

$${S}_{n} = π ( {r}_{n}^{2} - {r}_{n - 1}^{2} ) .$$

$$Region n + 1 : {S}_{n + 1} = π ( {R}^{2} - {r}_{n}^{2} )$$

The heat generated by each turn of the heating wire is allocated in two adjacent regions. It is assumed that the heat is uniformly allocated according to area proportions as follows.

Thermal energy allocated to region 1:

$${P}_{{S}_{1}} = {P}_{1} \frac{{S}_{1}}{{S}_{1} + {S}_{2}} .$$

Thermal energy allocated to region 2:

$${P}_{{S}_{2}} = {P}_{1} \frac{{S}_{2}}{{S}_{1} + {S}_{2}} + {P}_{2} \frac{{S}_{2}}{{S}_{2} + {S}_{3}} .$$

Thermal energy allocated to region n−1:

$${P}_{{S}_{n - 1}} = {P}_{n - 2} \frac{{S}_{n - 1}}{{S}_{n - 2} + {S}_{n - 1}} + {P}_{n - 1} \frac{{S}_{n - 1}}{{S}_{n - 1} + {S}_{n}} .$$

Thermal energy allocated to region n:

$${P}_{{S}_{n}} = {P}_{n - 1} \frac{{S}_{n}}{{S}_{n - 1} + {S}_{n}} + {P}_{n} \frac{{S}_{n}}{{S}_{n} + {S}_{n + 1}} .$$

Thermal energy allocated to region n+1:

$${P}_{{S}_{n + 1}} = {P}_{n} \frac{{S}_{n + 1}}{{S}_{n} + {S}_{n + 1}} .$$

The temperatures of different regions are denoted as T₁, T₂, . . . , Tₙ₋₁, Tₙ, and Tₙ₊₁, respectively. It is assumed that the temperature at each position in each region is the same.

The radiative heat release quantities of different regions are calculated as follows.

Region 1:

$${E}_{1} = εδ {T}_{1}^{4} {S}_{1} .$$

Region 2:

$${E}_{2} = εδ {T}_{2}^{4} {S}_{2} .$$

Region n−1:

$${E}_{n - 1} = εδ {T}_{n - 1}^{4} {S}_{n - 1} .$$

Region n:

$${E}_{n} = εδ {T}_{n}^{4} {S}_{n} .$$

Region n+1:

$${E}_{n + 1} = εδ {T}_{n + 1}^{4} {S}_{n + 1} .$$

Under heat equilibrium, the following equation set needs to be satisfied.

Region 1: E₁=P_{S}_{₁}.

Region 2: E₂=P_{S}_{₂}.

Region n−1: Eₙ₋₁=P_{S}_{_{n−1}}.

Region n: Eₙ=P_{S}_{ₙ}.

Region n+1: Eₙ₊₁=P_{S}_{ₙ₊₁}:

As such, (n+1) equation sets are obtained, including (n+1) unknown variables (rₙ, P). By using compiling software, the radius of each turn of the heating wire and the thermal energy required to reach the target temperature can be ascertained.

The present application can be applied to related fields such as semiconductor processing and solid heat transfer. By enabling rapid and accurate calculation of the design dimensions of the heating wire, optimizing the heater design process, and allowing the ceramic heater to have excellent temperature uniformity, the present application offers convenience for practical engineering applications.

Based on the same inventive concept, an embodiment of the present application further provides a semiconductor ceramic heater using the design method for a semiconductor ceramic heater described above. The implementation solutions to problems provided by the semiconductor ceramic heater are similar to those described in the aforesaid method. Thus, for specific definitions in one or more embodiments of the semiconductor ceramic heater provided below, reference may be made to those provided above in the design method for a semiconductor ceramic heater, which will not be described here redundantly.

In an exemplary embodiment, provided is a semiconductor ceramic heater including a heating wire and a ceramic disc, where the heating wire is coiled around the ceramic disc in a form of concentric circular arcs; and a radius of each turn of the heating wire is determined using the design method for a semiconductor ceramic heater described above.

Each turn of the heating wire may be designed to have a plurality of shapes. By way of example, there are following three shapes: the first shape is a circular arc. The second shape is as follows: turns of the heating wire are sequentially defined as i=1, 2, . . . , n along a radius direction of the ceramic disc from a center of the ceramic disc; a j-th turn of the heating wire to an (n−1)-th turn of the heating wire are in a sawtooth shape; an n-th turn of the heating wire is in the sawtooth shape, or is a circular ring on which a plurality of circles are provided in a uniformly spaced manner; and 1<j<n−1. The third shape is as follows: each turn of the heating wire is a circular ring on which a plurality of circles are provided in a uniformly spaced manner; and a number of circles on an outside circular ring is greater than a number of circles on a neighboring inside circular ring.

The heating wire in the first shape is as shown in the following Embodiment 1 and Embodiment 2, and the heating wires in the second shape and the third shape are as shown in the following Embodiment 3.

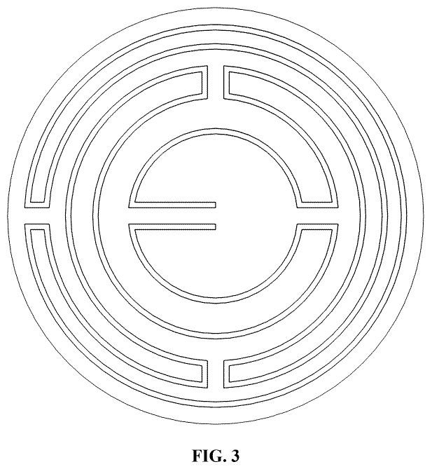

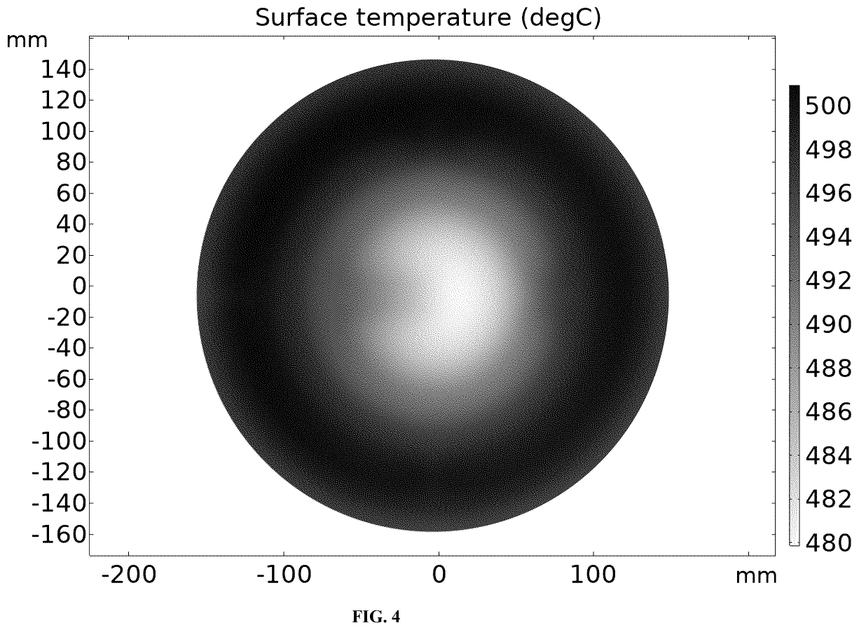

Embodiment 1: When n=5, rₙ is calculated, in units of mm. The units of P are J. The values of r₁, r₂, r₃, r₄, r₅, and P are 62.0670950596565, 87.8012106018174, 107.556810062063, 124.221154174734, 138.896972932923, and 2662, respectively. The heating wire is designed according to the radius, as shown in FIG. 3. The temperature field distribution is as shown in FIG. 4. When the temperature is raised to 500° C., the temperature difference is 4%.

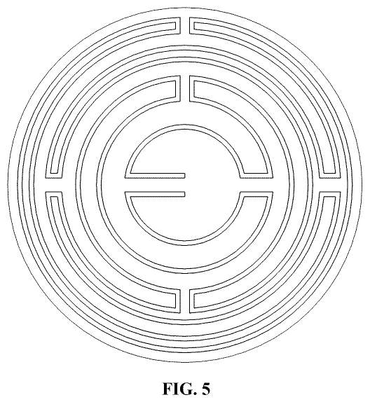

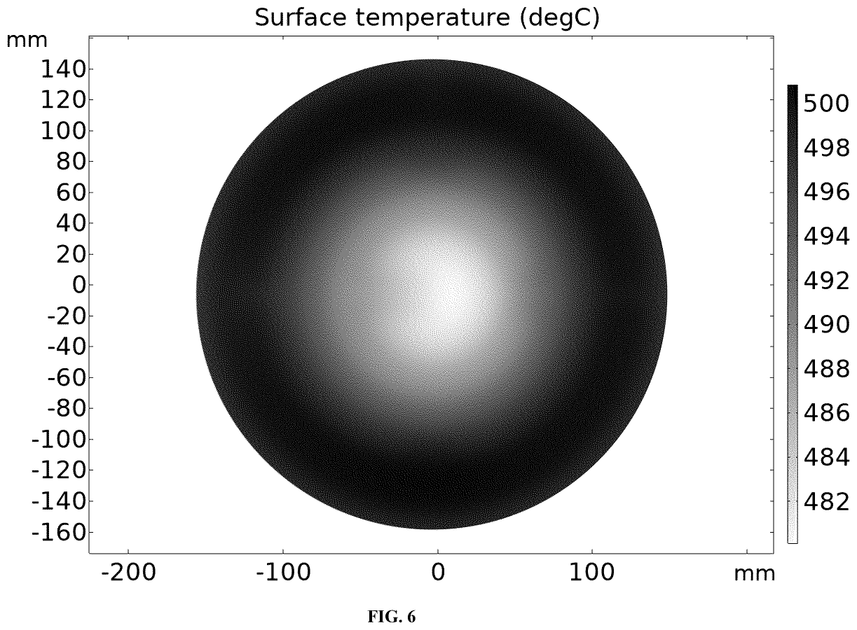

Embodiment 2: When n=7, In is calculated, in units of mm. The units of P are J. The values of r₁, r₂, r₃, r₄, r₅, r₆, r₇, and P are 52.9962267370447, 75.2168669021401, 92.3946141330819, 106.957708470854, 119.804364658660, 131.496627487765, 142.170856540175, and 2650, respectively. The heating wire is designed according to the radius, as shown in FIG. 5. The temperature field distribution is as shown in FIG. 6. When the temperature is raised to 500° C., the temperature difference is 3.6%.

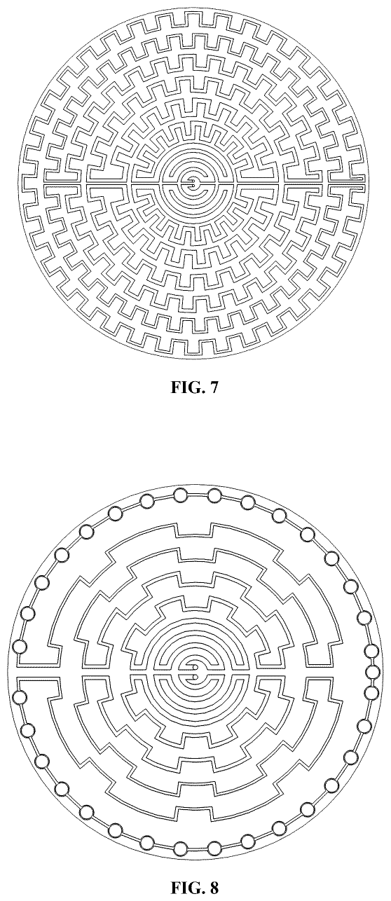

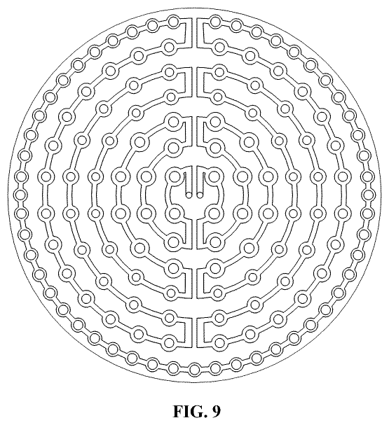

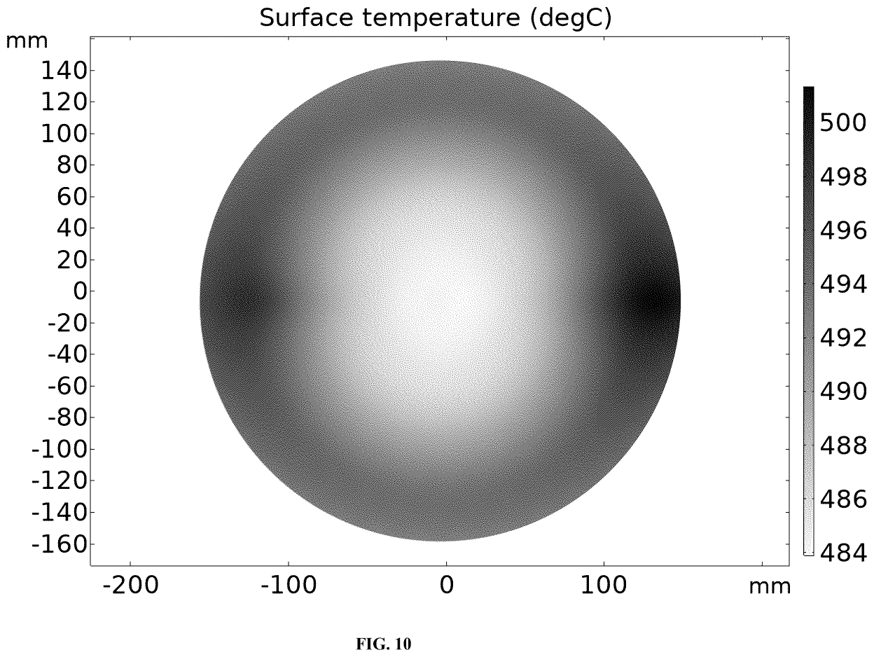

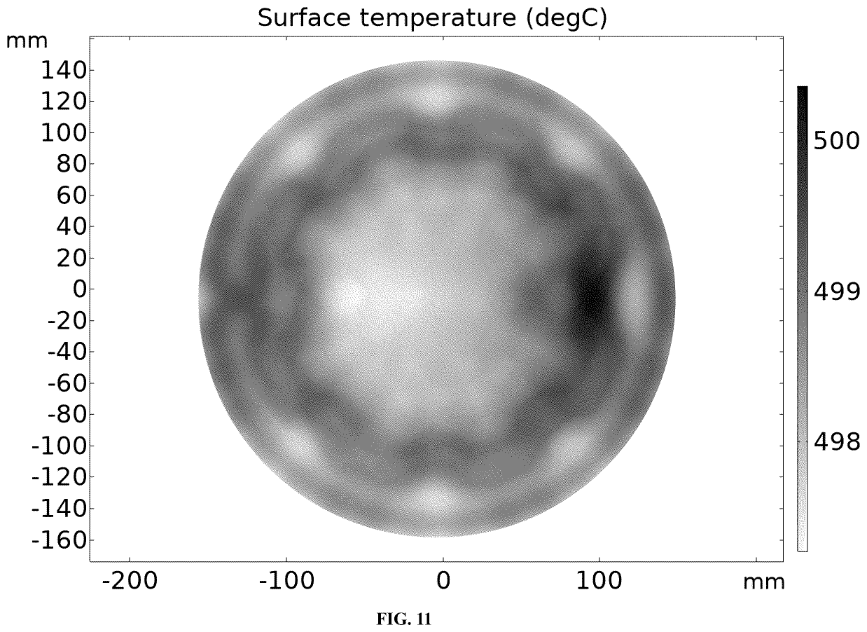

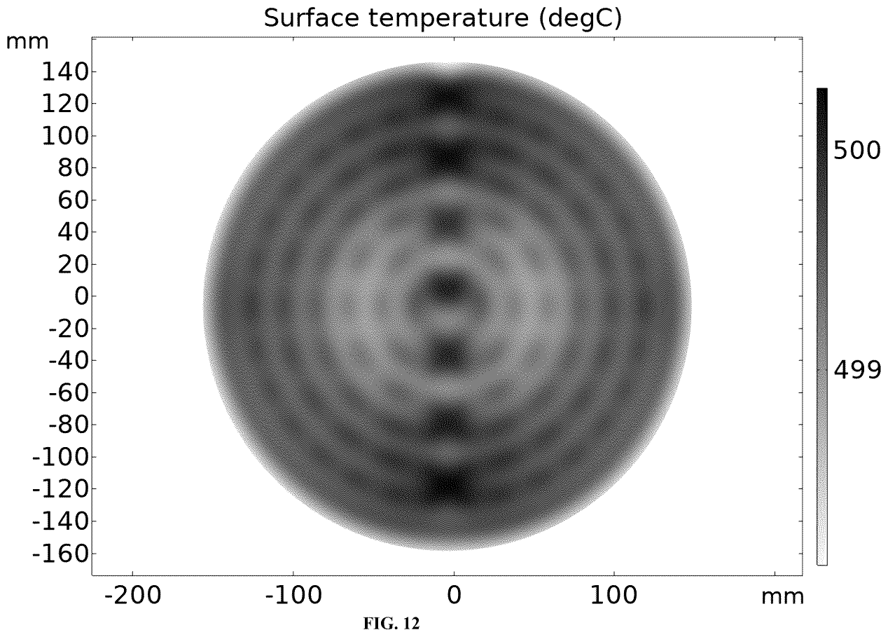

Embodiment 3: Considering that the shape and dimensions of the heating wire would affect the temperature uniformity of the ceramic heater to a certain extent, the heating wire is designed based on some specific patterns to provide reference for the design of ceramic heaters. A first specific pattern of heating wire distribution is as shown in FIG. 7, a second specific pattern is as shown in FIG. 8, and a third specific pattern is as shown in FIG. 9. The temperature field distribution of the first special pattern is as shown in FIG. 10. When the temperature is raised to 500° C., the temperature difference is 3.2%. The temperature field distribution of the second special pattern is as shown in FIG. 11. When the temperature is raised to 500° C., the temperature difference is 0.6%. The temperature field distribution of the third special pattern is as shown in FIG. 12. When the temperature is raised to 500° C., the temperature difference is 0.4%.

The technical features of the above embodiments may be combined arbitrarily. For brevity of description, all the possible combinations of the technical features in the above embodiments are not described. However, as long as there is no contradiction between the combinations of these technical features, they shall all fall within the scope of the specification.

Several examples are used herein for illustration of the principles and implementations of the present application. The description of the foregoing embodiments is used to help illustrate the method of the present application and the core principles thereof. In addition, those of ordinary skill in the art can make various modifications in terms of specific implementations and scope of application in accordance with the teachings of the present application. In conclusion, the content of the present specification shall not be construed as a limitation to the present application.

What is claimed is:

1. A design method for a semiconductor ceramic heater, comprising:
establishing a length expression for each turn of a heating wire of the semiconductor ceramic heater, the length expression being related to a radius of each turn of the heating wire;
determining an expression of thermal energy generated by each turn of the heating wire according to the length expression for each turn of the heating wire, the expression of the thermal energy being related to the radius of each turn of the heating wire and thermal energy required to reach a target temperature;
establishing an area expression for each region of a ceramic disc partitioned by the heating wire, the area expression being related to the radius of each turn of the heating wire;
determining a thermal energy model allocated to each region according to the area expression for each region and the expression of the thermal energy generated by each turn of the heating wire;
determining a radiative heat release quantity model of each region according to the area expression for each region and a target temperature of each region; and
calculating the radius of each turn of the heating wire and the thermal energy required to reach the target temperature by combining the thermal energy model allocated to each region and the radiative heat release quantity model of each region, specifically comprising:
in accordance with a principle that, under heat equilibrium, thermal energy allocated to each region is equal to a radiative heat release quantity from each region, combining the thermal energy model allocated to each region and the radiative heat release quantity model of each region to derive an equation set; and
solving the equation set to obtain the radius of each turn of the heating wire and the thermal energy required to reach the target temperature.

2. The design method for a semiconductor ceramic heater according to claim 1, wherein the length expression is as follows:
$${L}_{1} = 2 π {r}_{1} + {r}_{2} + {r}_{1} - 2 {d}_{0} ;$$
$${L}_{i} = 2 π {r}_{i} + {r}_{i + 1} - {r}_{i - 1} - 2 {d}_{0} ;$$
$${L}_{n} = 2 π {r}_{n} + {r}_{n} - {r}_{n - 1} - 2 {d}_{0} ;$$
wherein L₁ represents a length of a first turn of the heating wire; r₁ represents a radius of the first turn of the heating wire; r₂ represents a radius of a second turn of the heating wire; Lᵢ represents a length of an i-th turn of the heating wire; rᵢ represents a radius of the i-th turn of the heating wire; rᵢ₊₁ represents a radius of an (i+1)-th turn of the heating wire; rᵢ₋₁ represents a radius of an (i−1)-th turn of the heating wire; d₀ represents a spacing between the turns of the heating wire; Lₙ represents a length of an n-th turn of the heating wire; rₙ represents a radius of the n-th turn of the heating wire; rₙ₋₁ represents a radius of an (n−1)-th turn of the heating wire; i=1, 2, . . . , n−1; n represents a total number of turns of the heating wire; and the turns of the heating wire are sequentially defined as 1, 2, . . . , n along a radius direction of the ceramic disc from a center of the ceramic disc.

3. The design method for a semiconductor ceramic heater according to claim 1, wherein the determining an expression of thermal energy generated by each turn of the heating wire according to the length expression for each turn of the heating wire comprises:
establishing a total length expression of the heating wire according to the length expression of each turn of the heating wire and a total number of turns of the heating wire;
determining, according to the total length expression of the heating wire, a heat density expression as
$$η = \frac{P}{L} ,$$
wherein η represents a heat density; η represents the thermal energy required to reach the target temperature; and L represents a total length of the heating wire; and
combining the total length expression of the heating wire and the heat density expression to derive the expression of the thermal energy generated by each turn of the heating wire as Pᵢ=ηLᵢ, wherein Pᵢ represents thermal energy generated by an i-th turn of the heating wire, and Lᵢ represents a length of the i-th turn of the heating wire.

4. The design method for a semiconductor ceramic heater according to claim 1, wherein the area expression is as follows:
$${S}_{1} = π {r}_{1}^{2} ;$$
$${S}_{i} = π ( {r}_{i}^{2} - {r}_{i - 1}^{2} ) ;$$
$${S}_{n + 1} = π ( {R}^{2} - {r}_{n}^{2} ) ;$$
wherein S₁ represents an area of an enclosed region of the ceramic disc partitioned by a first turn of the heating wire; Sᵢ represents an area of a region of the ceramic disc partitioned by an i-th turn of the heating wire and an (i−1)-th turn of the heating wire; Sₙ₊₁ represents an area of a region of the ceramic disc partitioned by an n-th turn of the heating wire and an edge of the ceramic disc; r₁ represents a radius of the first turn of the heating wire; rt represents a radius of the i-th turn of the heating wire; rᵢ₋₁ represents a radius of the (i−1)-th turn of the heating wire; rₙ represents a radius of the n-th turn of the heating wire; R represents a radius of the ceramic disc; i=2, . . . , n; n represents a total number of turns of the heating wire; and the turns of the heating wire are sequentially defined as 1, 2, . . . , n along a radius direction of the ceramic disc from a center of the ceramic disc.

5. The design method for a semiconductor ceramic heater according to claim 1, wherein the thermal energy model is expressed as:
$${P}_{{S}_{1}} = {P}_{1} \frac{{S}_{1}}{{S}_{1} + {S}_{2}} ;$$
$${P}_{{S}_{i}} = {P}_{i - 1} \frac{{S}_{i}}{{S}_{i - 1} + {S}_{i}} + {P}_{i} \frac{{S}_{i}}{{S}_{i} + {S}_{i + 1}} ;$$
$${P}_{{S}_{n + 1}} = {P}_{n} \frac{{S}_{n + 1}}{{S}_{n} + {S}_{n + 1}} ;$$
wherein P_{S}_{₁} represents thermal energy allocated to an enclosed region of the ceramic disc partitioned by a first turn of the heating wire; P_{S}_{ᵢ} represents thermal energy allocated to a region of the ceramic disc partitioned by an i-th turn of the heating wire and an (i−1)-th turn of the heating wire; P_{S}_{ₙ₊₁} represents thermal energy allocated to a region of the ceramic disc partitioned by an n-th turn of the heating wire and an edge of the ceramic disc; P₁ represents thermal energy generated by the first turn of the heating wire; Pᵢ₋₁ represents thermal energy generated by the (i−1)-th turn of the heating wire; Pᵢ represents thermal energy generated by the i-th turn of the heating wire; Pₙ represents thermal energy generated by the n-th turn of the heating wire; S₁ represents an area of the enclosed region of the ceramic disc partitioned by the first turn of the heating wire; S₂ represents an area of a region of the ceramic disc partitioned by a second turn of the heating wire and the first turn of the heating wire; Sᵢ₋₁ represents an area of a region of the ceramic disc partitioned by the (i−1)-th turn of the heating wire and an (i−2)-th turn of the heating wire; Sᵢ represents an area of the region of the ceramic disc partitioned by the i-th turn of the heating wire and the (i−1)-th turn of the heating wire; Sᵢ₊₁ represents an area of a region of the ceramic disc partitioned by an (i+1)-th turn of the heating wire and the i-th turn of the heating wire; Sₙ represents an area of a region of the ceramic disc partitioned by the n-th turn of the heating wire and an (n−1)-th turn of the heating wire; Sₙ₊₁ represents an area of the region of the ceramic disc partitioned by the n-th turn of the heating wire and the edge of the ceramic disc; i=2, . . . , n; n represents a total number of turns of the heating wire; and the turns of the heating wire are sequentially defined as 1, 2, . . . , n along a radius direction of the ceramic disc from a center of the ceramic disc.

6. The design method for a semiconductor ceramic heater according to claim 1, wherein the radiative heat release quantity model is expressed as:
$${E}_{i} = εδ {T}_{i}^{4} {S}_{i} ;$$
$${E}_{n + 1} = εδ {T}_{n + 1}^{4} {S}_{n + 1} ;$$
wherein Eᵢ represents a radiative heat release quantity from an enclosed region of the ceramic disc partitioned by an i-th turn of the heating wire and an (i−1)-th turn of the heating wire; Eₙ₊₁ represents a radiative heat release quantity from a region of the ceramic disc partitioned by an n-th turn of the heating wire and an edge of the ceramic disc; ε represents a surface radiative emissivity; ε represents the Boltzmann constant; Tᵢ represents a target temperature of a region of the ceramic disc partitioned by the i-th turn of the heating wire and the (i−1)-th turn of the heating wire; Tₙ₊₁ represents a target temperature of the region of the ceramic disc partitioned by the n-th turn of the heating wire and the edge of the ceramic disc; Sᵢ represents an area of the region of the ceramic disc partitioned by the i-th turn of the heating wire and the (i−1)-th turn of the heating wire; Sₙ₊₁ represents an area of the region of the ceramic disc partitioned by the n-th turn of the heating wire and the edge of the ceramic disc; i=1, 2, . . . , n; n represents a total number of turns of the heating wire; and the turns of the heating wire are sequentially defined as 1, 2, . . . , n along a radius direction of the ceramic disc from a center of the ceramic disc.

7. A semiconductor ceramic heater, comprising: a heating wire and a ceramic disc;
wherein the heating wire is coiled around the ceramic disc in a form of concentric circular arcs; and
a radius of each turn of the heating wire is determined using the design method for a semiconductor ceramic heater according to claim 1.

8. The semiconductor ceramic heater according to claim 7, wherein turns of the heating wire are sequentially defined as 1, 2, . . . , n along a radius direction of the ceramic disc from a center of the ceramic disc;
a j-th turn of the heating wire to an (n−1)-th turn of the heating wire are in a sawtooth shape; an n-th turn of the heating wire is in the sawtooth shape, or is a circular ring on which a plurality of circles are provided in a uniformly spaced manner; and 1<j<n−1.

9. The semiconductor ceramic heater according to claim 7, wherein each turn of the heating wire is a circular ring on which a plurality of circles are provided in a uniformly spaced manner; and a number of circles on an outside circular ring is greater than a number of circles on a neighboring inside circular ring.

10. The semiconductor ceramic heater according to claim 7, wherein the length expression is as follows:
$${L}_{1} = 2 π {r}_{1} + {r}_{2} + {r}_{1} - 2 {d}_{0} ;$$
$${L}_{i} = 2 π {r}_{i} + {r}_{i + 1} - {r}_{i - 1} - 2 {d}_{0} ;$$
$${L}_{n} = 2 π {r}_{n} + {r}_{n} - {r}_{n - 1} - 2 {d}_{0} ;$$
wherein L₁ represents a length of a first turn of the heating wire; r₁ represents a radius of the first turn of the heating wire; r₂ represents a radius of a second turn of the heating wire; Lᵢ represents a length of an i-th turn of the heating wire; rᵢ represents a radius of the i-th turn of the heating wire; rᵢ₊₁ represents a radius of an (i+1)-th turn of the heating wire; rᵢ₋₁ represents a radius of an (i−1)-th turn of the heating wire; d₀ represents a spacing between the turns of the heating wire; Lₙ represents a length of an n-th turn of the heating wire; rₙ represents a radius of the n-th turn of the heating wire; rₙ₋₁ represents a radius of an (n−1)-th turn of the heating wire; i=1, 2, . . . , n−1; n represents a total number of turns of the heating wire; and the turns of the heating wire are sequentially defined as 1, 2, . . . , n along a radius direction of the ceramic disc from a center of the ceramic disc.

11. The semiconductor ceramic heater according to claim 7, wherein the determining an expression of thermal energy generated by each turn of the heating wire according to the length expression for each turn of the heating wire comprises:
establishing a total length expression of the heating wire according to the length expression of each turn of the heating wire and a total number of turns of the heating wire;
determining, according to the total length expression of the heating wire, a heat density expression as
$$η = \frac{P}{L} ,$$
wherein η represents a heat density; η represents the thermal energy required to reach the target temperature; and L represents a total length of the heating wire; and
combining the total length expression of the heating wire and the heat density expression to derive the expression of the thermal energy generated by each turn of the heating wire as Pᵢ=ηLᵢ, wherein Pᵢ represents thermal energy generated by an i-th turn of the heating wire, and Lᵢ represents a length of the i-th turn of the heating wire.

12. The semiconductor ceramic heater according to claim 7, wherein the area expression is as follows:
$${S}_{1} = π {r}_{1}^{2} ;$$
$${S}_{i} = π ( {r}_{i}^{2} - {r}_{i - 1}^{2} ) ;$$
$${S}_{n + 1} = π ( {R}^{2} - {r}_{n}^{2} ) ;$$
wherein S₁ represents an area of an enclosed region of the ceramic disc partitioned by a first turn of the heating wire; Sᵢ represents an area of a region of the ceramic disc partitioned by an i-th turn of the heating wire and an (i−1)-th turn of the heating wire; Sₙ₊₁ represents an area of a region of the ceramic disc partitioned by an n-th turn of the heating wire and an edge of the ceramic disc; r₁ represents a radius of the first turn of the heating wire; rᵢ represents a radius of the i-th turn of the heating wire; rᵢ₋₁ represents a radius of the (i−1)-th turn of the heating wire; rₙ represents a radius of the n-th turn of the heating wire; R represents a radius of the ceramic disc; i−2, . . . , n; n represents a total number of turns of the heating wire; and the turns of the heating wire are sequentially defined as 1, 2, . . . , n along a radius direction of the ceramic disc from a center of the ceramic disc.

13. The semiconductor ceramic heater according to claim 7, wherein the thermal energy model is expressed as:
$${P}_{{S}_{1}} = {P}_{1} \frac{{S}_{1}}{{S}_{1} + {S}_{2}} ;$$
$${P}_{{S}_{i}} = {P}_{i - 1} \frac{{S}_{i}}{{S}_{i - 1} + {S}_{i}} + {P}_{i} \frac{{S}_{i}}{{S}_{i} + {S}_{i + 1}} ;$$
$${P}_{{S}_{n + 1}} = {P}_{n} \frac{{S}_{n + 1}}{{S}_{n} + {S}_{n + 1}} ;$$
wherein P_{S}_{₁} represents thermal energy allocated to an enclosed region of the ceramic disc partitioned by a first turn of the heating wire; P_{S}_{ᵢ} represents thermal energy allocated to a region of the ceramic disc partitioned by an i-th turn of the heating wire and an (i−1)-th turn of the heating wire; P_{S}_{ₙ₊₁} represents thermal energy allocated to a region of the ceramic disc partitioned by an n-th turn of the heating wire and an edge of the ceramic disc; P₁ represents thermal energy generated by the first turn of the heating wire; Pᵢ₋₁ represents thermal energy generated by the (i−1)-th turn of the heating wire; Pᵢ represents thermal energy generated by the i-th turn of the heating wire; Pₙ represents thermal energy generated by the n-th turn of the heating wire; S₁ represents an area of the enclosed region of the ceramic disc partitioned by the first turn of the heating wire; S₂ represents an area of a region of the ceramic disc partitioned by a second turn of the heating wire and the first turn of the heating wire; Sᵢ₋₁ represents an area of a region of the ceramic disc partitioned by the (i−1)-th turn of the heating wire and an (i−2)-th turn of the heating wire; Sᵢ represents an area of the region of the ceramic disc partitioned by the i-th turn of the heating wire and the (i−1)-th turn of the heating wire; Sᵢ₊₁ represents an area of a region of the ceramic disc partitioned by an (i+1)-th turn of the heating wire and the i-th turn of the heating wire; Sₙ represents an area of a region of the ceramic disc partitioned by the n-th turn of the heating wire and an (n−1)-th turn of the heating wire; Sₙ₊₁ represents an area of the region of the ceramic disc partitioned by the n-th turn of the heating wire and the edge of the ceramic disc; i=2, . . . , n; n represents a total number of turns of the heating wire; and the turns of the heating wire are sequentially defined as 1, 2, . . . , n along a radius direction of the ceramic disc from a center of the ceramic disc.

14. The semiconductor ceramic heater according to claim 7, wherein the radiative heat release quantity model is expressed as:
$${E}_{i} = εδ {T}_{i}^{4} {S}_{i} ;$$
$${E}_{n + 1} = εδ {T}_{n + 1}^{4} {S}_{n + 1} ;$$
wherein Eᵢ represents a radiative heat release quantity from an enclosed region of the ceramic disc partitioned by an i-th turn of the heating wire and an (i−1)-th turn of the heating wire; Eₙ₊₁ represents a radiative heat release quantity from a region of the ceramic disc partitioned by an n-th turn of the heating wire and an edge of the ceramic disc; ε represents a surface radiative emissivity; ε represents the Boltzmann constant; Tᵢ represents a target temperature of a region of the ceramic disc partitioned by the i-th turn of the heating wire and the (i−1)-th turn of the heating wire; Tₙ₊₁ represents a target temperature of the region of the ceramic disc partitioned by the n-th turn of the heating wire and the edge of the ceramic disc; Sᵢ represents an area of the region of the ceramic disc partitioned by the i-th turn of the heating wire and the (i−1)-th turn of the heating wire; Sₙ₊₁ represents an area of the region of the ceramic disc partitioned by the n-th turn of the heating wire and the edge of the ceramic disc; i=1, 2, . . . , n; n represents a total number of turns of the heating wire; and the turns of the heating wire are sequentially defined as 1, 2, . . . , n along a radius direction of the ceramic disc from a center of the ceramic disc.
